(19) United States
(12) Patent Application Publication
(10) Pub. No.: US 2003/0107980 A1
(43) Pub. Date: Jun. 12, 2003

(54) Multiple wavelength optical pickup head

(76) Inventors: Hsi-Fu Shih, Hsinchu City (TW); Wei-Chih Lu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/196,288

(22) Filed: Jul. 17, 2002

(30) Foreign Application Priority Data
Dec. 7, 2001 (TW) 90130353

(51) Int. Cl. G11B 7/135

(52) U.S. Cl. 369/112.17; 369/121

(57) ABSTRACT

The invention is a multiple wavelength optical pickup head. It contains at least three laser beam generating units for generating laser beams with different wavelengths, a beam guiding unit installed on the optical path of the pickup head to guide the propagation of the laser beams, and a photo-detector that converts light signals into the corresponding electrical signals. The beam guiding unit includes a diffractive optical element and a convergent objective lens. After the laser beam generating units send out laser beams, the beam guiding unit leads them to the diffractive optical element so that the laser beams have different diffraction angles and effects. Through the focus of the convergent objective lens, the laser beams are converged to the data surfaces of optical recording media and reflected to the photo-detector, retrieving data from at least three kinds of optical recording media each with a kind of data storage densities.

### BACKGROUND OF THE INVENTION

1. Field of Invention

The invention relates to an optical pickup head for accessing data in an optical recording medium and, in particular, to an optical pickup head that uses multiple laser beams (at least three) each with a kind of wavelengths to access data stored on optical recording media (at least three) each with a kind of data storage densities.

2. Related Art

The technique of using an optical pickup head to access data on an optical recording medium is well known to the field. As the storage capacity and storage density of the optical recording medium increases, the optical pickup head structure has been continuously improved. Two characters of the evolution are that the wavelength of the laser beam to access the optical recording medium becomes shorter and the NA (Numerical Aperture) of the convergent objective lens gets larger. (The focal point of the laser beam thus gets smaller in size because the size is proportional to the wavelength of the laser beam, but inversely proportional to the NA.) These efforts are to keep up with the optical recording media with increasing storage capacities and densities.

Furthermore, new optical pickup heads have to be compatible with old formats in design. That is, they have to be able to access both new and old optical recording media. Therefore, in addition to sending out laser beams with a shorter wavelength for accessing data on new optical recording media, the new optical pickup head has to be able to send out laser beams with longer wavelengths or to use other methods to access old optical recording media. Consequently, several optical pickup head designs that can access two kinds of optical recording media each with a kind of data storage densities (such as CD and DVD) had been developed. These designs are briefly reviewed in the following paragraphs. As shown in FIGS. 1A and 1B, the convergent objective lens having two focal points that can generate different NA's having an HOE (Holographic Optical Element) 1. When the laser beam generated by the laser beam generating unit propagates to the HOE 1, it is diffracted by the HOE 1 then part of it converged by a convergent objective lens 2 onto one kind of optical recording media 40 each with a kind of storage capacities. Using the character of forming to diffraction angles by the HOE 1 and the fact that the convergent objective lens 2 can converge the two laser beams at two different focal points (on data surfaces of two optical recording media each with a kind of data storage densities), data stored in two different densities on the different optical recording media can be retrieved.

As shown in FIG. 2, the pickup head makes the laser beams of different wavelengths generated by the two laser beam generating units 3, 4 propagate along individual optical paths to the convergent objective lens 2. They then form focal points of different sizes corresponding to the laser beams of different wavelengths and NA's. Reflected by different optical recording media 40, each beam of different wavelengths returns back to a photo-detector 5 or the beam generating unit 4 (the beam generating unit 4 simultaneously has the photo detection function). This then achieves the objective of accessing one kind of the optical recording media 40 each with a kind of data storage densities.

The optical pickup head shown in FIG. 3 uses laser beams of two different wavelengths generated by two beam generating units 3a, 3b. With different optical paths and optical devices, the laser beams each with a kind of wavelengths are converged by convergent objective lenses 2a, 2b onto different focal points (on data surfaces of an optical recording medium 40 with a kind of data storage densities). After being reflected from the optical recording media 40 and returning back to the photo detector 5 or the beam generating unit 3b (the beam generating unit 3b also has the photo detection function), the data stored on the optical recording media 40 each with a kind of data storage densities can be accessed.

Although the above-mentioned optical pickup heads can access two kinds of optical recording media each with a kind of data storage densities, the demand for an optical recording medium with a higher density storage density forces us to have an even smaller focal point in order to access such a new medium. Therefore, the old optical pickup head cannot directly access the new optical recording medium using the existing optical systems. Due to the requirement of compatibility with old optical systems, the future high-density optical pickup head has to be able to access the two previously mentioned optical recording media each with a kind of data storage densities (such as CD's and DVD's). However, when expanding the function of accessing the new optical recording medium to the old optical systems will be impossible. Since the convergent objective lens described in the U.S. Pat. No. 5,446,565 only has two focal points, and the others need more complicated structures to own that function. Accordingly, it is highly desirable to develop an expendable optical pickup head that has a simple structure and can access at least CD, DVD and the new type high-density optical recording medium, or more than three kinds of media each with a kind of storage densities.

### SUMMARY OF THE INVENTION

A primary objective of the invention is to provide a multiple wavelength optical pickup head so as to perform data access on one of at least three kinds of optical recording media each with a kind of data storage densities. A special optical path design is proposed for a simple structure of the pickup head.

The disclosed multiple wavelength optical pickup head has at least three laser beam generating units, each for producing a kind of laser beam each with a kind of wavelengths, a beam guiding unit, and a photo-detector. The laser beam generating units produce laser beams with a kind of wavelengths each. The beam guiding unit is installed on the optical path of the pickup head for guiding the laser beams produced by the laser beam generating units. It includes a diffractive optical element and a convergent objective lens. The photo detector is also installed on the optical path of the pickup head. After the laser beam generating units produce the laser beams, the beam guiding unit leads the propagation of the laser beams to the diffractive optical element so that the laser beams each with a kind of wavelengths have different diffraction angles and effects. Through the focus of the convergent objective lens, the laser beams are converged to the data surfaces of optical recording media each with a kind of data storage densities. The converged laser beams are then reflected by the optical recording media, carry data signals stored thereon, and return along the previous optical path back to the photo-detector. The photo detector converts the received light signals into the corresponding electrical signals. Thus, the pickup head can access data stored on three kinds of optical recording media each with a kind of data storage densities.

### BRIEF DESCRIPTION OF THE DRAWINGS

The invention will become more fully understood from the detailed description given hereinbelow illustration only, and thus are not limitative of the present invention, and wherein:

FIGS. 1A and 1B are a compound convergent objective lens having two focal points that can generate different NA's disclosed in the prior art;

FIG. 2 is a conventional optical pickup head with two wavelengths;

FIG. 3 is another conventional optical pickup head with two wavelengths;

FIG. 4 shows the configuration of devices in the invention;

FIG. 5 shows the optical path for one laser beam generated by a laser beam generating unit to propagate along;

FIG. 6 is a schematic view of laser beams of different wavelengths, each laser beam being converged onto an optical recording medium by a convergent objective lens after changing their optical paths due to the diffractive optical element;

FIGS. 7A, 7B, and 7C show the electrode designs on the liquid crystal diffractive optical element for diffracting laser beams of different wavelengths;

FIGS. 8A, 8B, and 8C are focusing error signals formed when the different laser beams with a kind of wavelengths access the corresponding optical recording media;

FIG. 9 is another optical path for another laser beam generated by another laser beam generating unit to propagate along;

FIG. 10 is the other optical path for the other laser beam generated by the other laser beam generating unit to propagate along;

FIG. 11 is another embodiment of the invention;

FIG. 12 shows the structure of the multiple laser beam generating unit in FIG. 11; and

FIG. 13 is a schematic view of the detection areas of the photo-detector in FIG. 11.

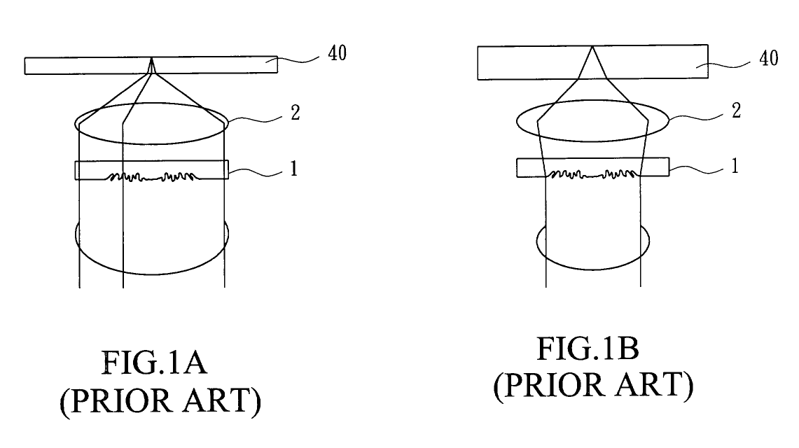

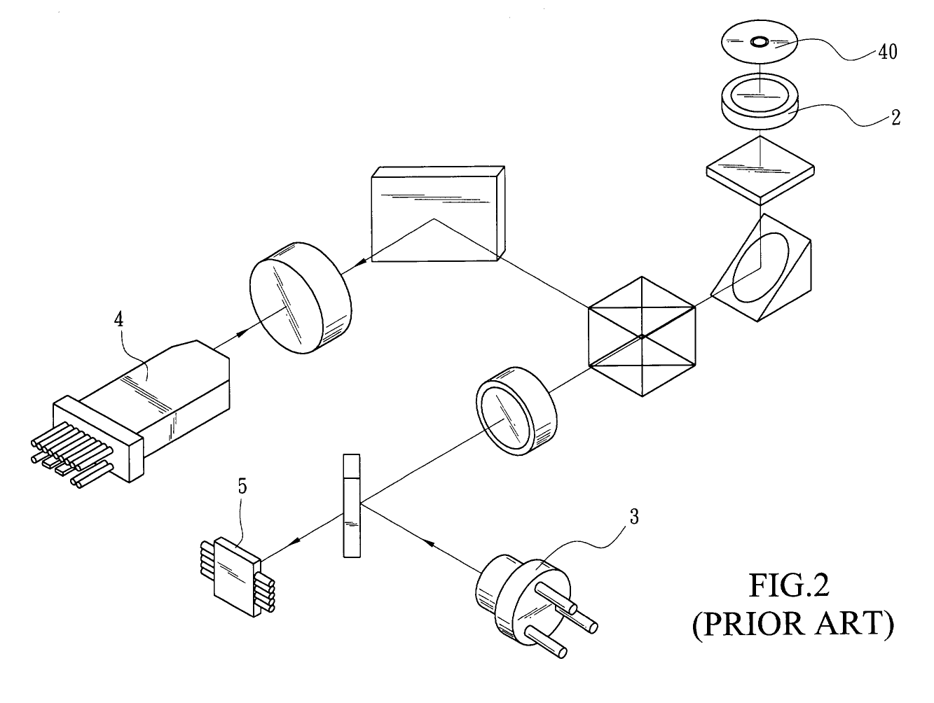

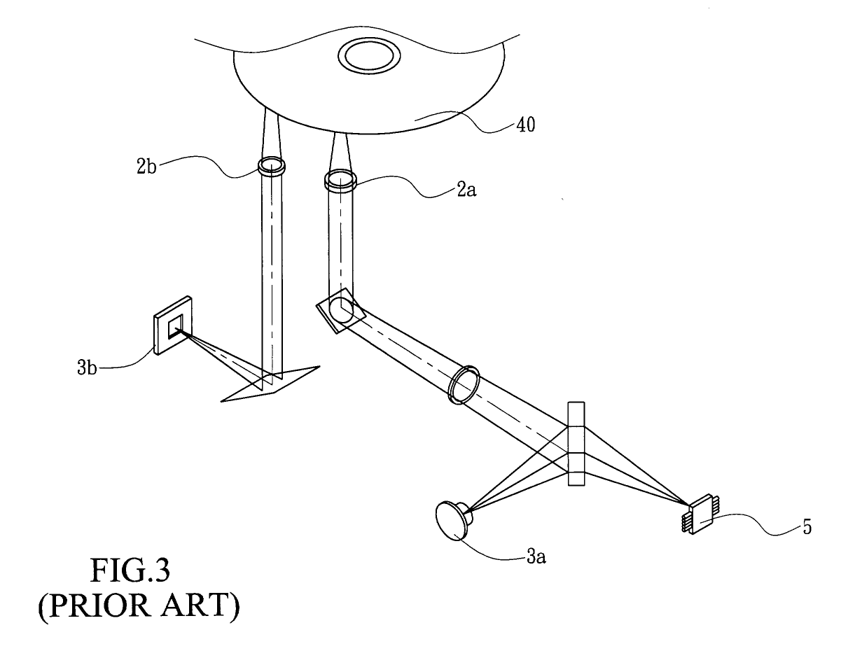

### DETAILED DESCRIPTION OF THE INVENTION

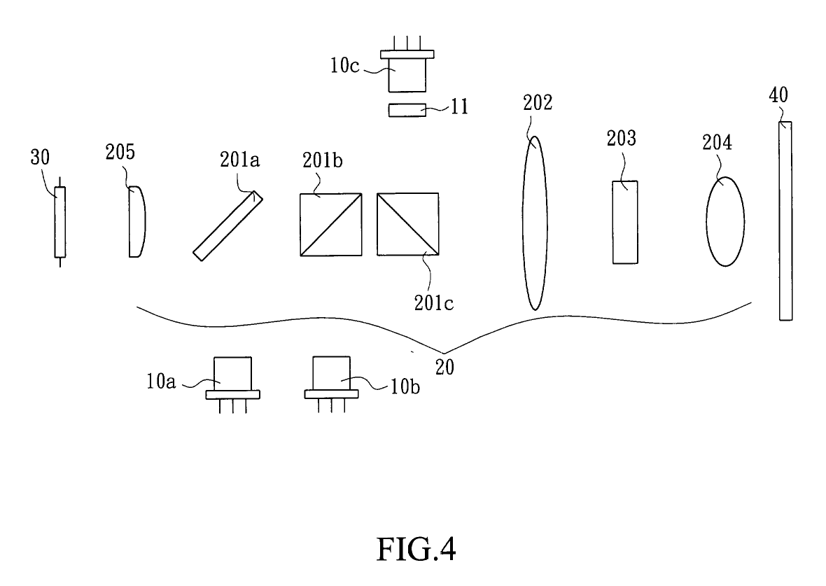

As shown in FIG. 4, the disclosed multiple wavelength optical pickup head can access data on at least three kinds of optical recording media 40 each with a kind of data storage densities (only one medium as shown). So one medium 40 has one kind of data storage densities. It has laser beam generating units 10a, 10b, 10c, a beam guiding unit 20, and a photo-detector 30.

The laser beam generating units 10a, 10b, 10c, each produce a kind of laser beams each with a kind of wavelengths to access a kind of optical recording media 40 each with a kind of data storage densities. So, a laser beam that produced by a laser beam generating unit (one of 10a, 10b, 10c) with a specific wavelength can access an optical recording medium with a specific data storage density. One of the laser beam generating units 10c has a corresponding 3-beam grating so that the laser beam produced by the laser beam generating unit 10c forms a tracking beam. The beam guiding unit 20 is installed on the optical path of the pickup head for guiding the laser beams produced by the laser beam generating units 10a, 10b, 10c. The beams each with a kind of wavelengths are then converged onto the data surfaces of the different optical recording media 40 and get reflected back to the photo detector 30. The beam guiding unit 20 includes beam splitters 201a, 201b, 201c, a collimating lens 202, a diffractive optical element 203, a convergent objective lens 204, and a cylindrical lens 205.

The beam splitter 201a, 201b, 201c are dichroic beam splitters installed on the optical path of the pickup head, corresponding to the laser beam generating units 10a, 10b, 10c for reflecting the different laser beams generated by the laser beam generating units 10a, 10b, 10c to propagate along the optical path of the pickup head. The laser beams reflected by the different optical recording media 40 also pass through the dichroic beam splitters 201a, 201b, 201c. Of course, each of the dichroic beam splitters 201a, 201b, 201c makes the corresponding laser beam generated by the corresponding laser beam generating unit 10a, 10b, or 10c to partially penetrate through and partially get reflected, while allowing laser beams of other wavelengths to totally penetrate through. The positions of the beam splitters 201a, 201b, 201c are installed on the optical path without definite orders (namely, it does not matter which is put in the front and which is put later), as long as the three beam splitters 201a, 201b, 201c can reflect the corresponding laser beams generated by the laser beam generating units 10a, 10b, 10c to the collimating lens 202.

The collimating lens 202 is installed on the optical path of the pickup head for converting laser beams reflected from the beam splitters 201a, 201b, 201c into parallel beams, and making the laser beams reflected from the different optical recording media 40 to pass through.

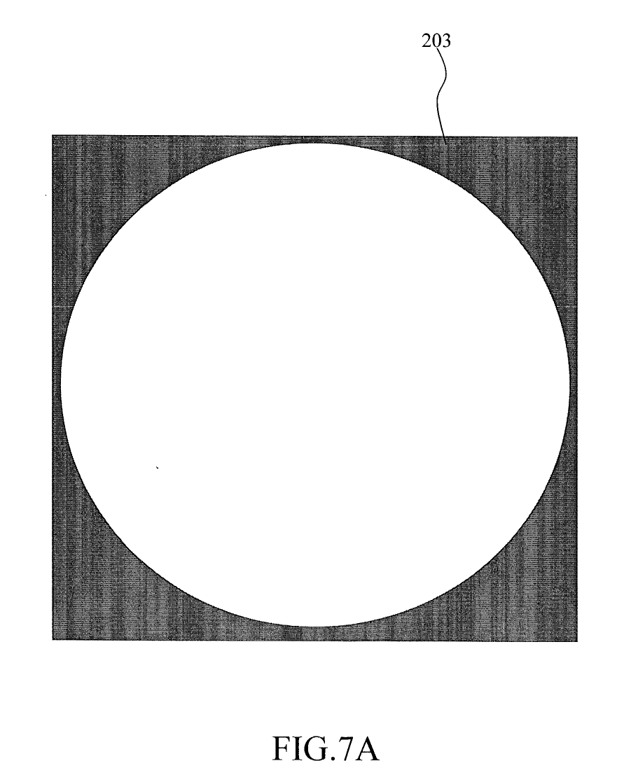

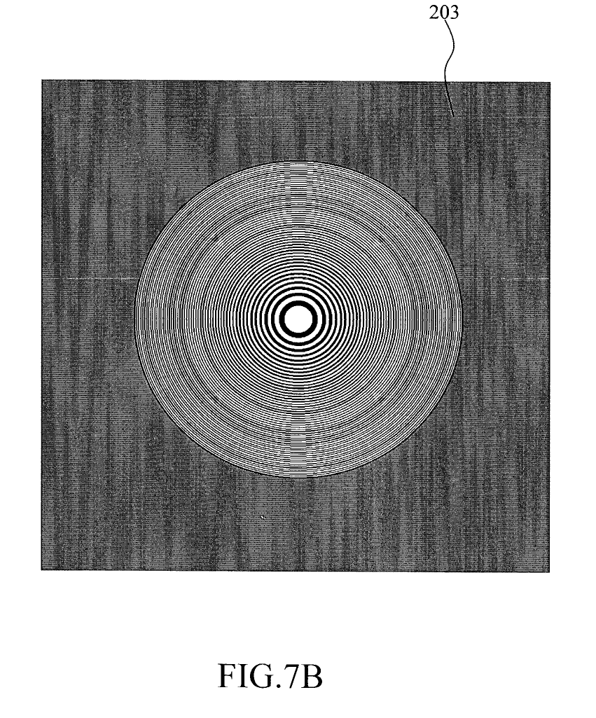

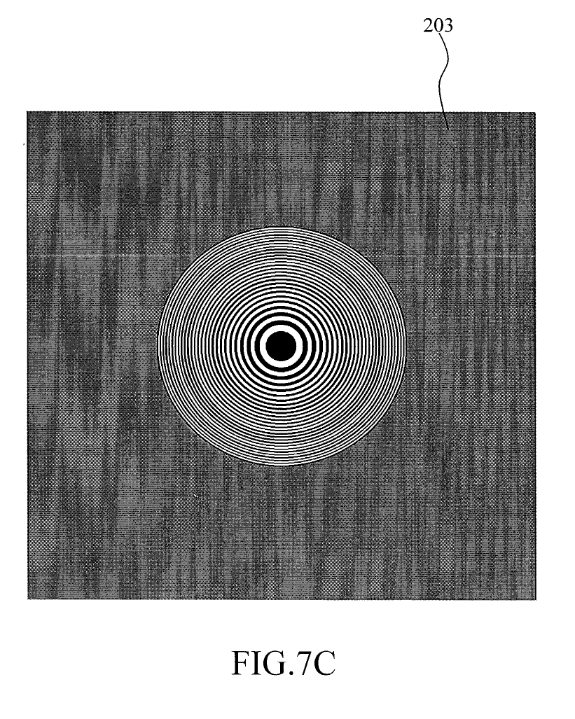

The diffractive optical element 203 is a liquid crystal diffractive optical element (LCDOE) installed on the optical path of the pickup head for the laser beams passing through the collimating lens 202 and the laser beams reflected by the different optical recording media 40 to pass through. The surface of the diffractive optical element 203 has a design of electrodes with concentric curve distribution and is imposed with a voltage from an external power supply. Varying the voltage can change the aperture that laser beams can pass through (corresponding to the NA value of the convergent objective lens) and periodically modulate the refraction index of the liquid crystal molecules inside the diffractive optical element 203 (as shown in FIGS. 7B and 7C). This changes the diffractive property of the diffractive optical element 203, correcting the spherical aberration caused due to the substrate thickness of the different optical recording media 40. Therefore, laser beams of different wavelengths have different diffraction angles and effects. After being converged by the convergent objective lens 204, the laser beams form focal points of different sizes.

The convergent objective lens 204 has a high NA value. It is installed on the optical path of the pickup head for the laser beams of different wavelengths diffracted by the diffractive optical element 203 to pass through and get converged to the corresponding data surfaces of different data storage densities on the optical recording media 40. The returning beams reflected from the different optical recording media 40 also pass through the convergent objective lens 204.

The cylindrical lens 205 is installed on the optical path of the pickup head for the laser beams reflected from the different optical recording media 40 and carrying data signals stored on one of the optical recording media 40 to pass through and form a focusing error signal.

The photo-detector 30 is used to receive the laser beams containing the data signals stored on one of the optical recording media 40 from the cylindrical lens 205. It further converts the light signals in the laser beams into the corresponding electrical signals.

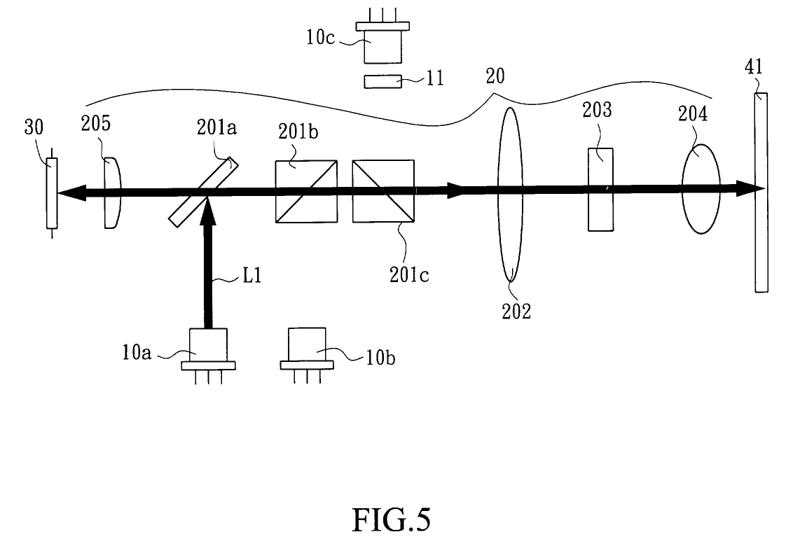

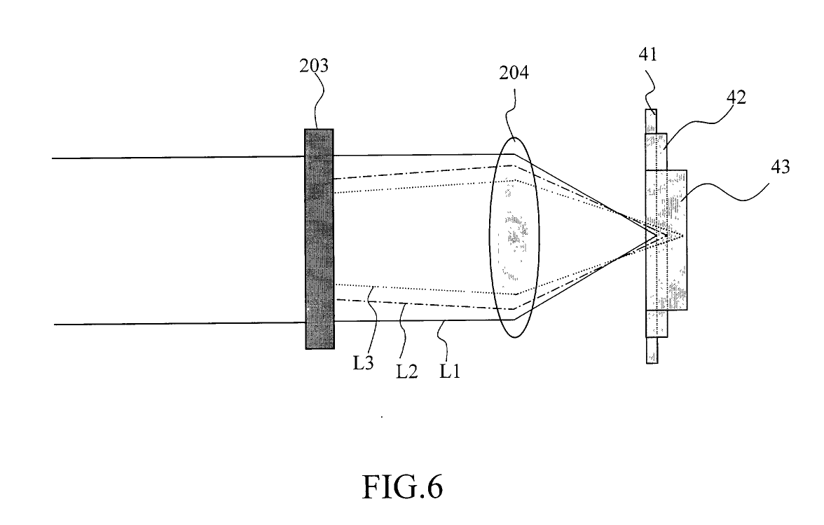

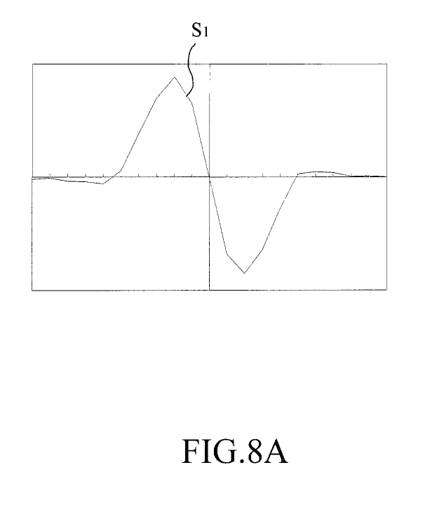

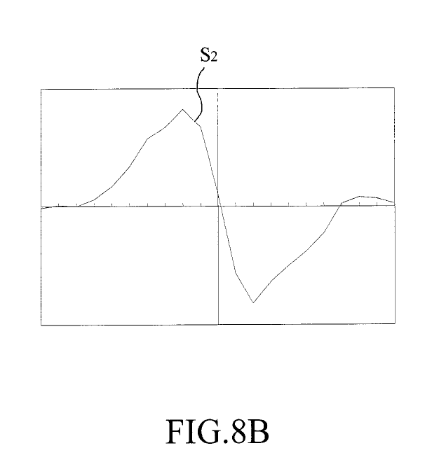

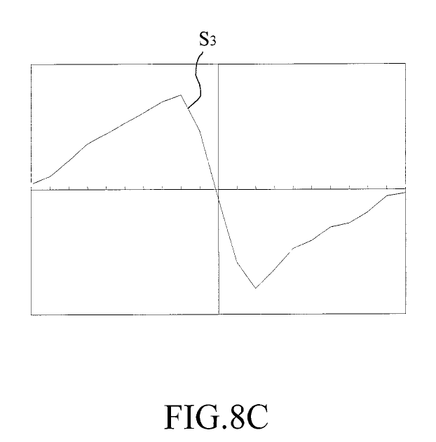

As shown in FIG. 5, when the pickup head accesses an optical recording medium 41 with a first data storage density, the laser beam generating unit 10a produces a laser beam L1 with a specific wavelength that can access the optical recording medium 41. The beam splitter 201a corresponding to the laser beam generating unit 10a splits the laser beam L1 so that part of it is reflected to propagate along the optical path. The collimating lens 202 converts the laser beam L1 reflected from the beam splitter 201a into a parallel beam. Afterwards, the laser beam L1 totally passes through the diffractive optical element 203 and gets converged by the convergent objective lens 204 onto the data surface of the optical recording medium 41 (as L1 shown in FIG. 6). At this moment, the diffractive optical element 203 does not have an external voltage imposed thereon and, therefore, the refraction index of the liquid crystal molecules inside the diffractive optical element 203 is not changed (FIG. 7A). The diffractive optical element 203 does not have any refractive effect now. The optical recording medium 41 reflects the converged laser beam L1 so that it returns following the previous optical path. The returning beam passes through the beam splitter 201a and reaches the cylindrical lens 205, forming a focusing error signal S1 (FIG. 8A). The photo-detector 30 receives the focusing error signal S1 and converts the light signals in the laser beam L1 into the corresponding electrical signals.

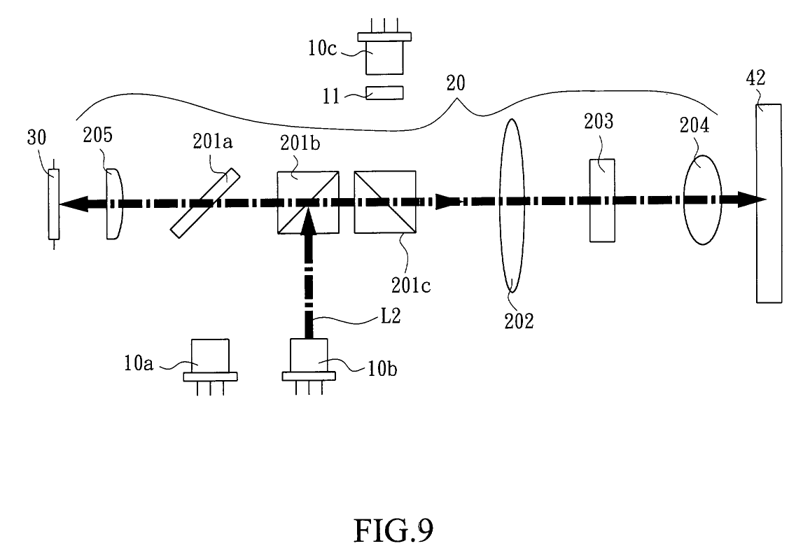

As shown in FIG. 9, when the pickup head accesses an optical recording medium 42 with a second data storage density, the laser beam generating unit 10b produces a laser beam L2 with a specific wavelength (different from that of L1) that can access the optical recording medium 42. The beam splitter 201b corresponding to the laser beam generating unit 10b splits the laser beam L2 so that part of it is reflected to propagate along the optical path. At the moment, the laser beam L2, as the laser beam L1, travels through in order the collimating lens 202, the diffractive optical element 203, the convergent objective lens 204, and gets converged onto the data surface of the optical recording medium 42. Afterwards, the optical recording medium 42 reflects the converged laser beam L2 so that it returns following the previous optical path. The returning beam passes through the beam splitter 201b and reaches the cylindrical lens 205, forming a focusing error signal S2 (FIG. 8B). The photo-detector 30 receives the focusing error signal S2 and converts the light signals in the laser beam L2 into the corresponding electrical signals.

The difference between accessing the optical recording medium 41 with the first data storage density and accessing the optical storage medium 42 with the second data storage density is as follows. When the laser beam L2 passes through the diffractive optical element 203, the diffractive optical element 203 changes the diameter of the range that the laser beam L2 can pass through (corresponding to the NA value of the convergent objective lens 204) due to an external voltage imposed on a first set of electrode on the surface of the diffractive optical element 203, and the refraction index of the liquid crystal molecules inside the diffractive optical element 203 is periodically modulated (FIG. 7B). Therefore, the diffractive optical element can diffract laser beams (e.g. L2 in FIG. 6). Through the convergence of the convergent objective lens 204, the laser beam L2 form a focal point different from that of the previous laser beam L1. The spherical aberration caused by the substrate thickness of the optical recording medium 42 is also corrected.

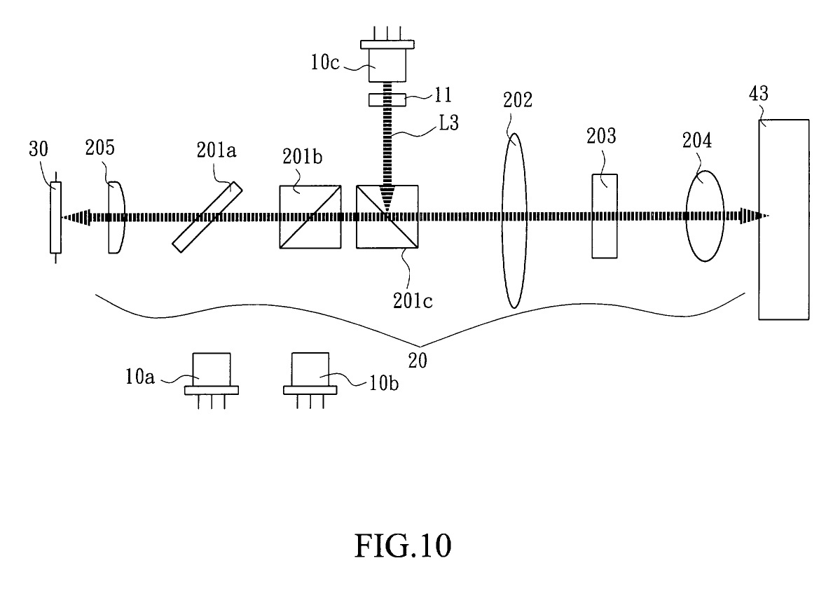

As shown in FIG. 10, when the pickup head accesses an optical recording medium 43 with a third data storage density, the laser beam generating unit 10c produces a laser beam L3 with a specific wavelength (different from those of L1 and L2) that can access the optical recording medium 43. The laser beam L3 forms tracking beams after passing through the 3-beam grating 11. The beam splitter 201c corresponding to the laser beam generating unit 10c then splits the laser beam L3 so that part of it is reflected to propagate along the optical path. At the moment, the laser beam L3, as the laser beams L1 and L2, travels through in order the collimating lens 202, the diffractive optical element 203, the convergent objective lens 204, and gets converged onto the data surface of the optical recording medium 43. Afterwards, the optical recording medium 43 reflects the converged laser beam L3 so that it returns following the previous optical path. The returning beam passes through the beam splitter 201c and reaches the cylindrical lens 205, forming a focusing error signal S3 (FIG. 8C). The photo-detector 30 receives the focusing error signal S3 and converts the light signals in the laser beam L3 into the corresponding electrical signals.

The difference between accessing the optical recording medium 43 with the third data storage density and the previous two cases is in that when the laser beam L3 passes through the diffractive optical element 203, the diffractive optical element 203 changes the diameter of the range that the laser beam L3 can pass through (corresponding to the NA value of the convergent objective lens 204) due to an external voltage imposed on a second set of electrode on the surface of the diffractive optical element 203, and the refraction index of the liquid crystal molecules inside the diffractive optical element 203 is periodically modulated (FIG. 7C). Therefore, the diffractive optical element can diffract laser beams (e.g. L3 in FIG. 6). Through the convergence of the convergent objective lens 204, the laser beam L3 form a focal point different from those of the previous laser beams L1 and L2. The spherical aberration caused by the substrate thickness of the optical recording medium 43 is also corrected.

In practice, the pickup head can have laser beam generating unit 10a, 10b, 10c generating, respectively, a laser beam L1 with a wavelength 405 nm, a laser beam L2 with a wavelength 650 nm, and a laser beam L3 with a wavelength 780 nm. The diffractive optical element 203 allows these three laser beams L1, L2, L3 to either directly penetrate through or to be diffracted. Through the convergence of the convergent objective lens 204, the laser beams are converged into focal points corresponding to NA values of 0.7˜0.9, 0.6, 0.45 on the convergent objective lens 204. Each of them can access one kind of optical recording media 40 each with a kind of data storage densities and thicknesses of 0.1-0.6 mm, 0.6 mm, and 1.2 mm (namely, the new type of optical recording medium, DVD, and CD). The invention can also generate laser beams of other wavelengths to access other types of optical recording media. In this case, the wavelengths of the laser beams L1, L2, L3 are not necessarily 405 mm, 650 mm, and 780 mm, as described before, but could be other more suitable ones. The NA values of the convergent objective lens 204 are not limited to 0.7˜0.9, 0.6, and 0.45, either.

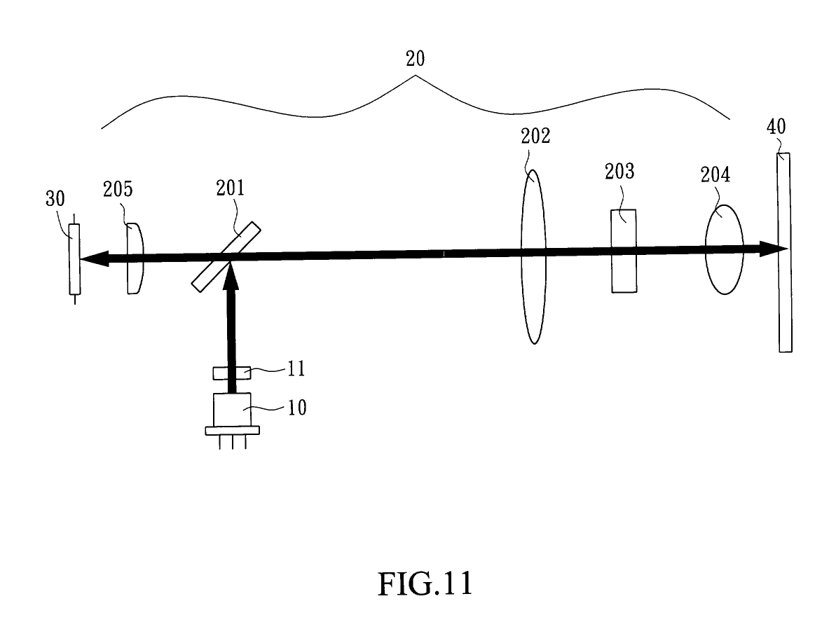

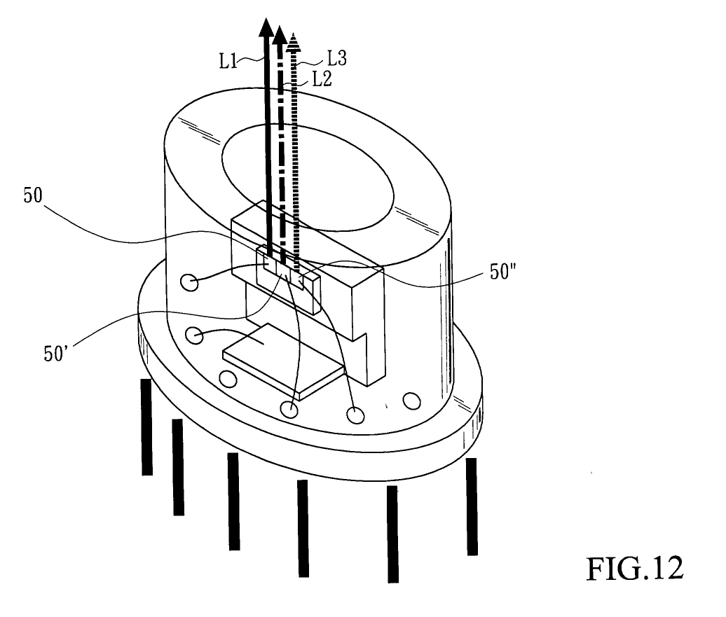

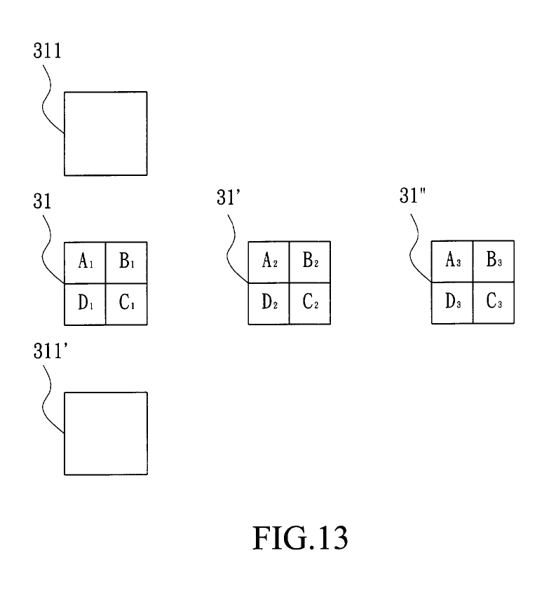

As illustrated in FIGS. 11, 12 and 13, another embodiment of the invention integrates the laser beam generating units 10a, 10b, and 10c into a laser beam generating unit 10 that can produce laser beams of multiple wavelengths. That is, this multiple wavelength laser beam generating unit 10 uses three different laser diodes 50, 50′, 50″ to selectively output laser beams (L1, L2, L3) of different wavelengths. It has the same configuration of the beam guiding unit 20 and the photo-detector 30 as in the previous embodiment, so that the pickup head can access three kinds of optical recording media 40 (only one as shown) each with a kind of data storage densities. In this embodiment, however, the photo detector 30 has three light detecting areas 31, 31′, 31″ (each being separated into four areas A1, B1, C1, D1; A2, B2, C2, D2; and A3, B3, C3, D3) for detecting the focusing error of the three laser beams (L1, L2, L3). Both sides of the detecting area 31 have tracking signal detecting areas 311, 311′ for generating tracking error signals. In addition, the beam splitters 201a, 201b, 201c of the beam guiding unit 20 can be replaced by a single beam splitter 201. Each of the laser beams L1, L2, L3 passing through the beam splitter 201 is reflected to propagate along the optical path of the pickup head.

Of course, the number of the laser beam generating units installed in the optical pickup head is not limited to three and could be more than three. The number of laser beams each with a kind of wavelengths generated by the multiple wavelength laser beam generating unit 10 can be more than three too, so as to access multiple (at least three) kinds of optical recording media each with a kind of data storage densities.

Effects of the Invention

Since the disclosed multiple wavelength optical pickup head has multiple (at least three) laser beam generating units to generate multiple (at least three) laser beams each with a kind of wavelengths and the accompanying liquid crystal diffractive optical element makes the convergent objective lens have multiple (at least three) NA values, it is thus expandable and can access multiple (at least three) optical recording media each with a kind of data storage densities. Furthermore, due to its special optical path design, the optical pickup head has a fairly simple structure.

What is claimed is:

1. A multiple wavelength optical pickup head for accessing data stored on at least three kinds of optical recording media each with a kind of data storage densities, which comprises:
at least three laser beam generating units to generate laser beams with different wavelengths;
a beam guiding unit, which is installed on the optical path of the pickup head for guiding and converging the laser beams with different wavelengths each onto a data surface of one of the optical recording media that store data signals in different data storage densities and reflect the laser beams, the beam guiding unit including a diffractive optical element and a convergent objective lens, wherein the diffractive optical element changes the aperture that the laser beams can pass through so the laser beams of different wavelengths form different diffraction angles and effects, and the convergent objective lens converges the diffracted laser beams onto the corresponding data surfaces each with a kind of data storage densities on different one of the optical recording media; and
a photo-detector, which receives the laser beams each reflected by one of the optical recording media and converts the received light signals contained in the laser beams into the corresponding electrical signals.

2. The optical pickup head of claim 1, wherein one of the laser beam generating units further contains a corresponding 3-beam grating to form tracking beams.

3. The optical pickup head of claim 1, wherein the beam guiding unit has:
at least three beam splitters, which are installed on the optical path of the pickup head and each corresponds to one of the laser beam generating units for splitting the corresponding laser beam while letting other laser beams pass through, part of the split laser beam being reflected to propagate along the optical path of the pickup head and the laser beams reflected by different kinds of the optical recording media passing through the corresponding beam splitters; and
a collimating lens, which is installed on the optical path of the pickup head for converting the split laser beams each reflected by the beam splitters into parallel beams, which then pass through the diffractive optical element and the convergent objective lens, and allowing the split laser beams each reflected from different kinds of the optical recording media to pass through.

4. The optical pickup head of claim 1, wherein the convergent objective lens is an objective lens with a large NA (Numerical Aperture) value.

5. The optical pickup head of claim 1, wherein the beam guiding unit further contains a cylindrical lens installed on the optical path of the pickup head for the laser beams each reflected by different kinds of the optical recording media and containing data signals recorded thereon to pass through, forming a focusing error signal.

6. The optical pickup head of claim 1, wherein the diffractive optical element is a liquid crystal diffractive optical element (LCDOE).

7. The optical pickup head of claim 6, wherein the diffractive optical element has at least two sets of electrodes, each of which is distributed in concentric curves and is imposed with an external voltage to change its aperture for the laser beams to pass through, and the refraction index of the liquid crystal molecules is periodically modulated, so that the diffractive optical element can diffract the laser beams, change the NA value of the convergent objective lens, and correct the spherical aberration caused by the change in the thickness of different kinds of the optical recording media.

8. A multiple wavelength optical pickup head for accessing data stored on at least three kinds of optical recording media each with a kind of data storage densities, which comprises:
a multiple wavelength laser beam generating unit, which selectively generates at least three laser beams with different wavelengths;
a beam guiding unit, which is installed on the optical path of the pickup head for guiding and converging the laser beams with different wavelengths each onto a data surface of one of the optical recording media that store data signals in different data storage densities and reflect the laser beams, the beam guiding unit including a diffractive optical element and a convergent objective lens, wherein the diffractive optical element changes the aperture that the laser beams can pass through so the laser beams of different wavelengths form different diffraction angles and effects, and the convergent objective lens converges the diffracted laser beams onto the corresponding data surfaces each with a kind of data storage densities on different one of the optical recording media; and
a photo-detector, which receives the laser beams each reflected by one of the optical recording media and converts the received light signals contained in the laser beams into the corresponding electrical signals.
a photo-detector device, which has at least three detection areas corresponding to the laser beams of different wavelengths to receive the laser beams each reflected by different kinds of the optical recording media and to convert the received light signals contained in the laser beams into the corresponding electrical signals.

9. The optical pickup head of claim 8, wherein the multiple wavelength laser beam generating unit further contains a 3-beam grating corresponding to one of the laser beams for forming tracking beams.

10. The optical pickup head of claim 8, wherein the beam guiding unit has:
a beam splitter, which is installed on the optical path of the pickup head and corresponds to the laser beam generating unit for splitting the corresponding laser beams, part of the split laser beams being reflected to propagate along the optical path of the pickup head and the laser beams reflected by different kinds of the optical recording media passing through the beam splitter; and
a collimating lens, which is installed on the optical path of the pickup head for converting the split laser beams each reflected by the beam splitters into parallel beams, which then pass through the diffractive optical element and the convergent objective lens, and allowing the split laser beams each reflected from different kinds of the optical recording media to pass through.

11. The optical pickup head of claim 8, wherein the convergent objective lens is an objective lens with a large NA (Numerical Aperture) value.

12. The optical pickup head of claim 8, wherein the beam guiding unit further contains a cylindrical lens installed on the optical path of the pickup head for the laser beams each reflected by different kinds of the optical recording media and containing data signals recorded thereon to pass through, forming a focusing error signal.

13. The optical pickup head of claim 8, wherein the diffractive optical element is a liquid crystal diffractive optical element (LCDOE).

14. The optical pickup head of claim 13, wherein the diffractive optical element has at least two sets of electrodes, each of which is distributed in concentric curves and is imposed with an external voltage to change its aperture for the laser beams to pass through, and the refraction index of the liquid crystal molecules is periodically modulated, so that the diffractive optical element can diffract the laser beams, change the NA value of the convergent objective lens, and correct the spherical aberration caused by the change in the thickness of different kinds of the optical recording media.
